(19) United States
(12) Patent Application Publication
(10) Pub. No.: US 2025/0209634 A1
(43) Pub. Date: Jun. 26, 2025

(54) COARSE ANNOTATION BASED SEMANTIC SEGMENTATION MODEL TRAINING METHOD AND DEVICE

(71) Applicant: HANGZHOU INNOVATION INSTITUTE, BEIHANG UNIVERSITY, Zhejiang (CN)

(72) Inventors: Zehua Fu, Zhejiang (CN); Jingchao Liu, Zhejiang (CN); Ye Du, Zhejiang (CN); Qingjie Liu, Zhejiang (CN); Yunhong Wang, Zhejiang (CN)

(21) Appl. No.: 18/851,880

(22) PCT Filed: Apr. 22, 2022
(86) PCT No.: PCT/CN2022/088384

§ 371 Date: Sep. 27, 2024

(51) Int. Cl. G06T 7/12; G06V 10/762; G06V 10/764; G06V 10/771

(52) U.S. Cl. CPC G06T 7/12; G06V 10/762; G06V 10/764; G06V 10/771

(57) ABSTRACT

The present disclosure relates to a coarse annotation based semantic segmentation model training method and device operating by sending an original image into a semantic segmentation model for processing; acquiring a semantic feature map output by a specified convolution layer in the semantic segmentation model; sending the semantic feature map to a first training branch for training to obtain a first cross entropy loss value, wherein the first training branch is a fully supervised branch depending on a ground-truth map; sending the semantic feature map to a second training branch for training to obtain a second cross entropy loss value, wherein the second training branch is an unsupervised branch without a ground-truth map; and determining an overall loss function according to the first cross entropy loss value and the second cross entropy loss value.

### TECHNICAL FIELD

The present disclosure relates to the technical field of artificial intelligence, in particular to a semantic segmentation model training method and device.

### BACKGROUND

In the field of computer vision, the current applications of neural networks mainly include image recognition, object localization and detection, and semantic segmentation. Image recognition is used to judge what the image is, object localization and detection is used to judge where the object is in the image, and semantic segmentation is used to answer the above two questions from the pixel level. The semantic segmentation task has a wide range of applications. In the field of autonomous driving, semantic segmentation can realize real-time analysis and recognition of the natural environment near the driving vehicle. In the field of remote sensing interpretation, semantic segmentation can realize the modeling of urban road networks from aerial images. In the field of medical diagnosis, the semantic segmentation task can realize the retinal blood vessel segmentation of medical images. Besides the schematic diagram in the accompanying drawings, semantic segmentation also plays an important role in practical applications such as image retrieval and augmented reality. Therefore, the semantic segmentation task can be regarded as the cornerstone of tasks related to scene understanding, analysis, recognition, and has a high theoretical research and application value.

The process of training a semantic segmentation model needs a lot of annotated data, and the annotated data are annotated pictures. Annotated data can be divided into three levels according to annotation granularity: “rectangular box annotation”, “polygon coarse annotation” and “pixel-by-pixel fine annotation”. FIG. 1a is an unannotated original image. As shown in FIG. 1b, pixel-by-pixel annotation can accurately indicate the specific class of each pixel, and black is used to refer to the negligible area unrelated to the autonomous driving task. As shown in FIG. 1c, polygon annotation only uses coarse polygons to roughly describe the shape outline of an object, and uses black to refer to both negligible and unmarked areas. As shown in FIG. 1d, rectangular box annotation uses a coarser rectangle to roughly describe the range where the object is located, and once again uses black to refer to both negligible areas and unmarked areas.

It can be seen that rectangular boxes are only suitable for describing the class of regular shapes such as vehicles and trees, but cannot accurately describe the class of irregular shapes such as roads, pedestrian paths, sky and walls. Moreover, even if only the classes of vehicles and trees are described, there will be overlapping problems between the marked rectangular boxes. There is a difference in the accuracy between the model trained by using rectangular box annotation and the fine annotation, so it is not appropriate to use rectangular boxes for annotation for applications involving complex scenes (such as autonomous driving). Using a coarse polygon for annotation can avoid the overlapping of regions, and it is more in line with the cognitive style of an annotator.

On the other hand, by replacing the original pixel-by-pixel fine annotation with this coarse annotation, the annotation time of a single image can be shortened from 90 minutes to 7 minutes, thus producing more annotated data with lower annotation costs. For example, a coarsely annotated data set containing 20,000 images can be constructed using 2,333 man-hours. In contrast, a finely annotated data set containing only 5,000 images needs 7,500 man-hours.

However, coarse annotation is not perfect. There is a lot of annotation noise in the outline of objects represented by polygons. By comparing the fine annotation in FIG. 2b with the coarse annotation in FIG. 2c, it can be seen that there are a large number of unannotated and incorrectly annotated pixels (black pixels in FIG. 2d) in the coarse annotation. These phenomena of unannotated and incorrectly annotated pixels greatly restrict the application scope of coarse annotation.

In order to avoid these annotated noises and make full use of these coarsely annotated data, the existing methods usually use a circuitous strategy, that is, the coarsely annotated data is only used in the pre-training stage of the model, and then the finely annotated data is used to fine-tune the model, and finally a high-accuracy prediction model is obtained. In other words, the existing methods only use coarsely annotated data as a supplement to finely annotated data, and it is considered that a high-accuracy prediction model can be obtained only using finely annotated data.

In related technologies, there is no technical scheme to train a semantic segmentation model only using coarsely annotated data.

### SUMMARY

In order to overcome the problems existing in the related technologies at least to a certain extent, the present disclosure provides a coarse annotation based semantic segmentation model training method and device.

According to the first aspect of the embodiment of the present disclosure, there is provided with a coarse annotation based semantic segmentation model training method, comprising the following steps:
sending an original image into a semantic segmentation model for processing;
acquiring a semantic feature map output by a specified convolution layer in the semantic segmentation model;
sending the semantic feature map to a first training branch for training to obtain a first cross entropy loss value, wherein the first training branch is a fully supervised branch depending on a ground-truth map;
sending the semantic feature map to a second training branch for training to obtain a second cross entropy loss value, wherein the second training branch is an unsupervised branch without a ground-truth map; and
determining an overall loss function according to the first cross entropy loss value and the second cross entropy loss value.

According to a second aspect of the embodiment of the present disclosure, there is provided with a coarse annotation based semantic segmentation model training device, comprising:
an input module, which is configured to send an original image into a semantic segmentation model for processing;
an acquisition module, which is configured to acquire a semantic feature map output by a specified convolution layer in the semantic segmentation model;
a first training branch, which is configured to train the semantic feature map to obtain a first cross entropy loss value, wherein the first training branch is a fully supervised branch depending on a ground-truth map;
a second training branch, which is configured to train the semantic feature map to obtain a second cross entropy loss value, wherein the second training branch is an unsupervised branch without a ground-truth map; and
a determining module, which is configured to determine an overall loss function according to the first cross entropy loss value and the second cross entropy loss value.

The technical scheme provided by the embodiment of the present disclosure has the following beneficial effects.

According to the scheme of the present disclosure, the semantic segmentation model is trained only using coarsely annotated data. Unsupervised clustering is performed on the unannotated pixel samples through a clustering algorithm, so that the number of samples participating in the training is greatly expanded. The scheme can make full use of the unannotated areas in the image; and on the premise of only using coarsely annotated data, can improve the prediction accuracy of the model as much as possible, thus reducing the annotation cost of semantic segmentation tasks.

It should be understood that the above general description and the following detailed description are only exemplary and illustrative, and cannot limit the present disclosure.

### BRIEF DESCRIPTION OF THE DRAWINGS

The drawings herein are incorporated into and constitute a part of the specification, illustrate embodiments consistent with the present disclosure, and together with the specification, serve to explain the principle of the present disclosure.

FIG. 1 is a schematic diagram of an original image, pixel-by-pixel annotation, polygon annotation and rectangular box annotation.

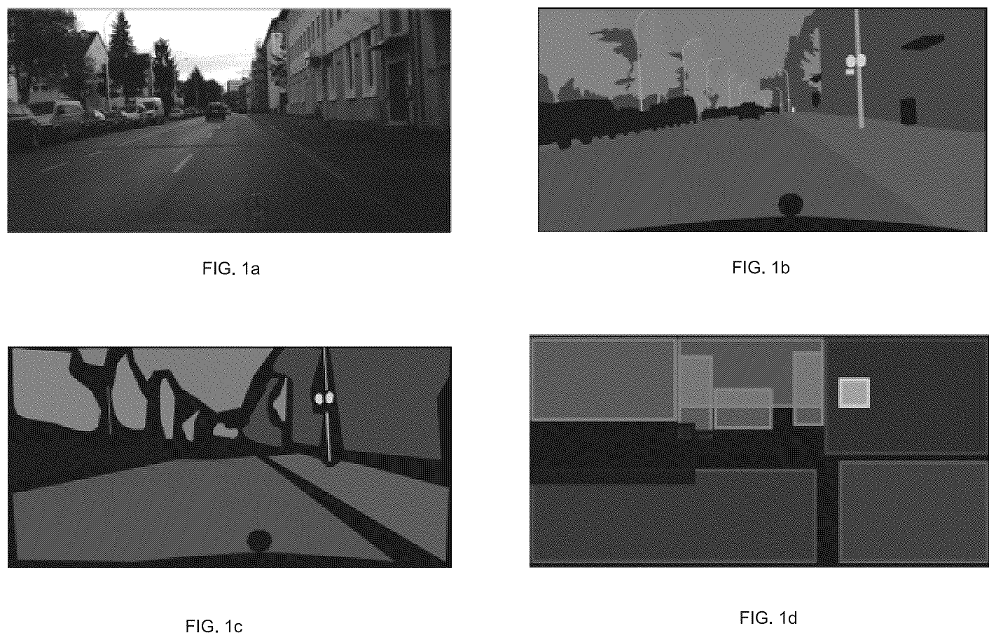

FIG. 2 is a schematic diagram of pixel division results in an original image, fine annotation, coarse annotation and coarse annotation.

FIG. 3 is a flow chart of a coarse annotation based semantic segmentation model training method according to an exemplary embodiment.

FIG. 4 is a schematic structural diagram of a semantic segmentation model according to an exemplary embodiment.

FIG. 5 is a schematic structural diagram of a semantic segmentation model containing two training branches according to an exemplary embodiment.

FIG. 6a is a schematic diagram of contrast stretching according to an exemplary embodiment.

FIG. 6b is a schematic diagram of sample semantic vector enhancement according to an exemplary embodiment.

FIG. 7a is a schematic diagram of the overall implementation of a contrast stretching module according to an exemplary embodiment.

FIG. 7b is a schematic diagram of the specific implementation of an enhancement function according to an exemplary embodiment.

FIG. 8 is a schematic diagram of an original image and a pixel variance according to an exemplary embodiment.

FIG. 9 is a schematic diagram of a training process of an automatic ARM according to an exemplary embodiment.

FIG. 10 is a schematic diagram of a variance average loss value according to an exemplary embodiment.

### DETAILED DESCRIPTION OF THE EMBODIMENTS

Exemplary embodiments will be described in detail here, examples of which are shown in the drawings. When the following description refers to the drawings, unless otherwise indicated, the same numbers in different drawings indicate the same or similar elements. The embodiments described in the following exemplary embodiments do not represent all the embodiments consistent with the present disclosure. On the contrary, they are only examples of methods and devices consistent with some aspects of the present disclosure as detailed in the appended claims.

First, the research status in the field is briefly introduced. In order to reduce the annotation cost of semantic segmentation, researchers have been proposing various solutions, the core ideas of which can be roughly divided into weakly supervised learning, semi-supervised learning, domain adaptive transfer learning, annotation expansion based on the video inter-frame continuity and interactive annotation. An overview of these solutions will be given hereinafter.

Among these solutions to reduce annotation costs, weakly supervised learning and semi-supervised learning are the two areas that are most concerned by researchers. The solution of weakly supervised learning is to weaken the fine pixel-by-pixel class annotation into the annotation type that provides less information, and then use the weakened annotation data to train the model. The weakened annotation types mainly include a rectangular bounding box that only provides the position information, class information and approximate shape information of the instance in the image, a single pixel that only provides the class information and approximate position information of the instance in the image, and a single class annotation value that only provides the class information of the instance. The solution of semi-supervised learning is: in addition to providing paired images and annotation, some unannotated images are introduced for joint training of the two data. As a whole, when weakly supervised learning wants to reduce the annotation time of a single image, semi-supervised learning introduces a set of images without annotation to expand the data set, thus sharing the annotation cost equally.

Generally speaking, how to reduce the annotation cost of semantic segmentation as much as possible on the premise of ensuring the prediction accuracy of a network model is a research direction with great academic value and application value.

Inspired by the work of weakly supervised segmentation at the rectangular box level and usability analysis of coarse annotation, this scheme will explore whether coarse annotation has the potential to produce a high-accuracy semantic segmentation model by itself. If coarse annotation can produce a high-accuracy model, the annotation cost of semantic segmentation-related applications can be greatly reduced, and the landing speed can be significantly improved. Therefore, this scheme introduces a task referred to as “semantic segmentation of coarse annotation”, and tries to improve the prediction accuracy of the model as much as possible on the premise of only using coarsely annotated data.

Although coarse annotation has reached a balance between labeling granularity and labeling cost, the existing research on such coarse annotation is almost zero. In order to exploit the huge potential of coarse annotation and reduce the annotation cost of a semantic segmentation task, this scheme will focus on “how to improve the prediction accuracy with only coarsely annotated data”. The main work is as follows.

(1) In order to make use of the unannotated areas in the image, this scheme performs unsupervised clustering on the unannotated samples, proposes a sample clustering algorithm based on intra-class similarity, and further improves the prediction accuracy of the clustering algorithm by using a class-centered normalization module and a contrast stretching module. The basic sample clustering algorithm can perform unsupervised clustering on the unannotated samples depending on the intra-class similarity, thus greatly expanding the number of samples participating in the training. The two enhancement modules further improve the clustering algorithm by “enhancing the difference of class-centered vectors” and “enhancing the expressiveness of sample vectors”, respectively.

(2) In order to suppress the pixel areas annotated incorrectly in the image, this scheme adjusts the sample weights of the incorrectly annotated samples. Specifically, this scheme introduces “class probability variance” as a new confidence index, and uses detailed statistical data to demonstrate that confidence weighting can achieve two tasks at the same time: “paying attention to correctly annotated high-value samples” and “suppressing incorrectly annotated high-risk samples”. In this scheme, a common confidence weighting strategy is further generalized into a confidence-based Adversarial Reweighting Module (ARM), which can effectively solve the problem of incorrect annotation.

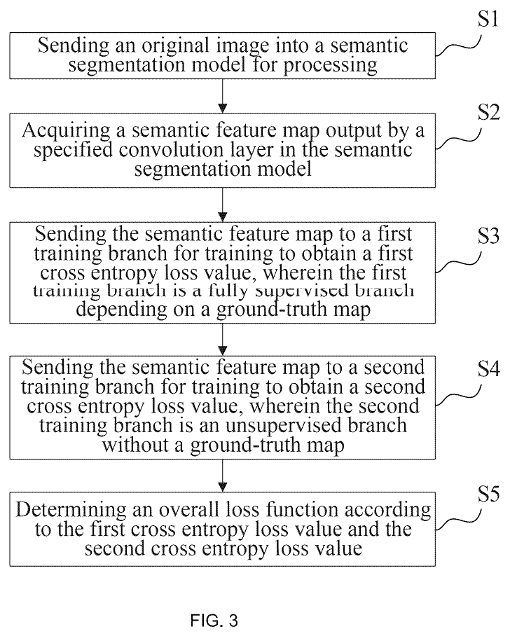

FIG. 3 is a flow chart of a coarse annotation based semantic segmentation model training method according to an exemplary embodiment. The method can comprise the following steps:
Step S1, sending an original image into a semantic segmentation model for processing;
Step S2, acquiring a semantic feature map output by a specified convolution layer in the semantic segmentation model;
Step S3, sending the semantic feature map to a first training branch for training to obtain a first cross entropy loss value, wherein the first training branch is a fully supervised branch depending on a ground-truth map;
Step S4, sending the semantic feature map to a second training branch for training to obtain a second cross entropy loss value, wherein the second training branch is an unsupervised branch without a ground-truth map; and
Step S5, determining an overall loss function according to the first cross entropy loss value and the second cross entropy loss value.

According to the scheme of the present disclosure, the semantic segmentation model is trained only using coarsely annotated data. Unsupervised clustering is performed on the unannotated pixel samples through a clustering algorithm, so that the number of samples participating in the training is greatly expanded. The scheme can make full use of the unannotated areas in the image; and on the premise of only using coarsely annotated data, can improve the prediction accuracy of the model as much as possible, thus reducing the annotation cost of semantic segmentation tasks.

It should be understood that although the steps in the flow chart of FIG. 3 are shown in sequence as indicated by arrows, these steps are not necessarily executed in sequence as indicated by arrows. Unless explicitly stated herein, the execution of these steps is not strictly limited in order, and these steps can be executed in other order. Furthermore, at least a part of the steps in FIG. 3 may include a plurality of sub-steps or stages, which are not necessarily completed at the same time, but maybe executed at different times. The execution order of these sub-steps or stages is not necessarily in sequence, but may be alternately executed with at least a part of other steps or sub-steps or stages of other steps.

### (1) Class-Centered Clustering Segmentation Method for the Problem of Annotation

For semantic segmentation annotation, there are two classes of annotations in the label map: one class of labels are the labels marked as a valid class, and the other class of labels are the labels marked as an invalid class. The labels of a valid class can be further subdivided into annotations of various semantic classes, while the annotations of invalid classes indicate that the pixels themselves are “irrelevant to the task defined by the data set” or “the semantic information is ambiguous”. Specifically, for Cityscapes data set, there are 19 valid semantic classes and 1 invalid semantic class in its annotation map.

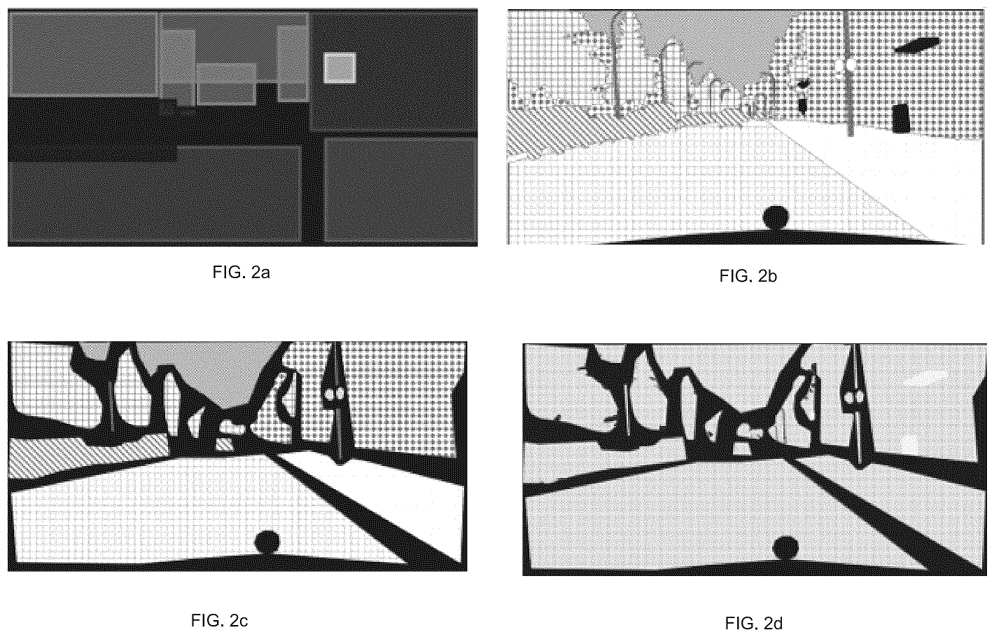

By marking the invalid semantic class as black, and the valid semantic class as a grid, a diagonal, etc., the results of the two annotations are shown in FIG. 2b and FIG. 2c. For the fine annotation which takes 1.5 hours for a single annotation (FIG. 2b), both valid pixels and invalid pixels in the image are correctly annotated. However, for the coarse annotation which takes 7 minutes for a single annotation (FIG. 2c), only some valid pixels are correctly annotated, and the remaining valid pixels are either incorrectly annotated as other classes (partially black areas in FIG. 2d) or not annotated directly (partially black areas in FIG. 2d), thus becoming invalid pixels. It can be seen that there are actually a large number of unannotated valid pixels in the coarse annotation.

Under the existing fully supervised training framework, the pixel points of invalid classes do not participate in the training. In order to quantitatively analyze the number of valid pixels and invalid pixels in the two annotations, this scheme counts 2950 training set images in Cityscapes data set. As shown in Table 1, the overall distribution of valid pixels and invalid pixels in the two annotations is counted first. It can be seen that since the two annotations share the same original image, the sum of the valid pixels and invalid pixels is 62.4×10⁸. In the fine annotation, the number of valid pixels can be up to 55.2×10⁸. In the coarse annotation, the number of valid pixels is reduced to 39.3×10⁸, which is only 71.2% of the fine annotation. If the 15.9×10⁸ unannotated valid pixels can be used in an unsupervised way, the prediction accuracy of the model can be improved from the perspective of expanding training samples.

TABLE 1
Comparison of the number of valid pixels between
coarse annotation and fine annotation

| | | | sum of the |
|---|---|---|---|
| In total | valid | invalid | pixels |
| Number of pixels in | 39.3 | 23.1 | 62.4 |
| coarse annotation (×10⁸) | | | |
| Number of pixels in fine | 55.2 | 7.2 | 62.4 |
| annotation (×10⁸) | | | |
| coarse annotation/fine annotation | 71.2% | 320.8% | 100% |

In addition, this scheme further counts the number distribution of 19 valid semantic classes in Cityscapes data set. As shown in Table 2, after switching from fine annotation to coarse annotation, except for the semantic class of “road”, which retains 89.2% of the valid pixels, most other classes only retain 35% to 70% of the valid pixels. In other words, after switching from fine annotation to coarse annotation, most classes will lose 30% to 65% of the valid pixels. From the distribution of pixel numbers among classes, the class of “road” only accounts for 20.4/55.2=37% of all valid samples in fine annotation, but accounts for 18.2/39.3=46% in the coarse annotation. This shows that the class imbalance will become more serious after using coarse annotation.

TABLE 2
Comparison of the number of valid pixels between coarse annotation and fine annotation

| Semantic class | Road | sidewalk | building | wall | fence | straight pole | traffic lights |
|---|---|---|---|---|---|---|---|
| Number of pixels in | 18.2 | 1.73 | 8.10 | 0.22 | 0.34 | 0.24 | 0.04 |
| coarse annotation (×10⁸) | | | | | | | |
| Number of pixels in | 20.4 | 3.36 | 12.6 | 0.36 | 0.49 | 0.68 | 0.12 |
| fine annotation (×10⁸) | | | | | | | |
| coarse annotation/ | 89.2% | 51.5% | 64.3% | 61.3% | 69.3% | 34.8% | 36.6% |
| fine annotation | | | | | | | |

| Semantic class | sign | plant | vegetation | sky | people | rider | car |
|---|---|---|---|---|---|---|---|
| Number of pixels in | 0.16 | 5.26 | 0.24 | 1.42 | 0.33 | 0.03 | 2.60 |
| coarse annotation (×10⁸) | | | | | | | |
| Number of pixels in | 0.31 | 8.79 | 0.64 | 2.21 | 0.67 | 0.07 | 3.86 |
| fine annotation (×10⁸) | | | | | | | |
| coarse annotation/ | 51.8% | 59.8% | 37.3% | 64.3% | 48.5% | 40.3% | 67.4% |
| fine annotation | | | | | | | |

| Semantic class | truck | bus | train | motorcycle | bike |
|---|---|---|---|---|---|
| Number of pixels in | 0.10 | 0.10 | 0.08 | 0.02 | 0.09 |
| coarse annotation (×10⁸) | | | | | |
| Number of pixels in | 0.15 | 0.13 | 0.13 | 0.05 | 0.23 |
| fine annotation (×10⁸) | | | | | |
| coarse annotation/ | 64.4% | 72.5% | 64.0% | 43.5% | 41.4% |
| fine annotation | | | | | |

To sum up, the research direction of this scheme is: to improve the model accuracy from the perspective of mining unannotated valid pixels. Specifically, first, the existing semantic segmentation model is formally represented, and the last fully connected layer of the model is reinterpreted as a set of class-centered vectors. On this basis, this scheme proposes a sample (pixel) clustering algorithm based on the class center, which tries to use the similarity between the sample and performs unsupervised class clustering on the unannotated pixels. By iteratively carrying out two steps of “classifying samples by using the class center” and “updating the class center by voting by using samples”, the effective training samples are greatly expanded without sample annotation. Moreover, in order to further improve the prediction accuracy of the model, this scheme also proposes a class-centered normalization module and a contrast stretching module for the clustering algorithm.

### 1. Class-Centric Clustering Algorithm

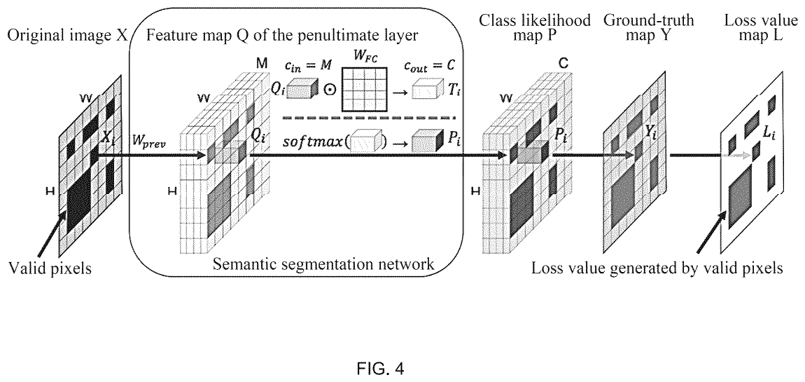

In order to describe the proposed class-centered clustering algorithm, this scheme attempts to re-express the whole semantic segmentation model. By dividing the whole model into “the last fully connected layer” and “the front entire network layer” and naming the parameters of these two parts as W_{FC} and Wₚᵣₑᵥ, this section redraws the flow chart of the existing fully supervised framework, as shown in FIG. 4.

In some embodiments, the “specified convolution layer” in step S2 is the penultimate layer of the semantic segmentation model; and the “first training branch” in step S3 is the last fully connected layer in the semantic segmentation model.

First, the original image will generate a feature map Q with “height H, width W and number of channels M” under the action of the model parameter Wₚᵣₑᵥ (that is, the semantic feature map output by the specified convolution layer). Thereafter, under the action of the model parameter W_{FC} and the softmax function, the feature map Q of the penultimate layer can obtain a final likelihood map P with “height H, width W and number of channels as the number of classes C”. Subsequently, by filtering out the valid pixels and calculating the loss function value, an iteration of training is completed.

For fine-grained description, in this scheme, the single pixel in the original image X is denoted as Xᵢ∈ [symbol] ³, the feature vector of the single pixel in the penultimate feature map Q is denoted as Qᵢ∈ [symbol] ^{M}, and the result of matrix multiplication (indicated by symbol ⊙) of Qᵢ by W_{FC} is denoted as Tᵢ, and the class probability distribution of the single pixel in the class likelihood map P is denoted as Pᵢ∈ [symbol] ^{C}. Finally, the true class of the valid pixels in the ground-truth map Y is marked as Yᵢ, and the corresponding loss value is denoted as Lᵢ (i.e. the first cross entropy loss value). The English of “ground-truth map” is the ground-truth map, which can also be referred to as semantic segmentation annotation.

After the framework described above is established, the relationship between various modules can be expressed more formally, as shown in the following formula:

Qᵢ=f(Xᵢ;Wₚᵣₑᵥ)

Tᵢ=W_{FC}□Qᵢ

Pᵢ=softmax(Tᵢ)

Lᵢ=CE(Pᵢ,Yᵢ) (1)

First, the pixel value Xᵢ is converted into the feature vector Qᵢ under the abstract mapping f controlled by the parameter Wₚᵣₑᵥ. Thereafter, the Qᵢ of the number of the input channels cᵢₙ=M performs matrix multiplication by the parameter W_{FC} (indicated by the symbol ⊙) so as to obtain the intermediate result Tᵢ of the number of the output channels cₒᵤₜ=C. Subsequently, the softmax function acts on Tᵢ, so as to obtain the class probability distribution Pᵢ. Finally, the cross entropy (CE) of Pᵢ and the ground-truth annotation Yᵢ is calculated, so as to obtain the loss value Lᵢ.

In some embodiments, sending the semantic feature map to a second training branch for training in step S3 comprises: performing unsupervised clustering on the semantic feature map, and classifying unannotated sample vectors. Specifically, from the perspective of class-centered vector clustering, unsupervised clustering is performed on the semantic feature map Q, so that the unannotated valid samples can be introduced into the training process. The sample vector is defined as the sample vector Qᵢ at each pixel position in the feature map Q. The unannotated sample vector vectors are the feature vectors corresponding to the unannotated pixel in the semantic feature map.

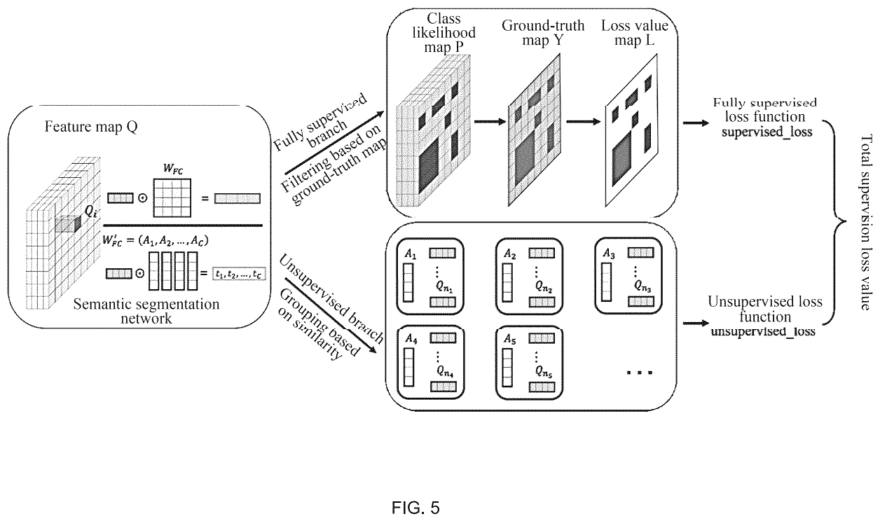

As shown in FIG. 5, in the semantic segmentation model, the feature map Q of the penultimate layer is input into two parallel training branches. The first training branch is the fully supervised branch which depends on the ground-truth map. This branch is completely consistent with the reference model described in FIG. 4, and only pixel points in the valid pixel area are used in the training process. The second training branch is an unsupervised branch without a ground-truth map. This branch will iteratively carry out two steps of “classifying samples by using the class center” and “updating the class center by voting by using samples”, and simultaneously train class-centered vectors and sample vectors. All pixel points in the image will be used in the training process. W_{FC} and W_{FC}′ share the parameters, so that the fully supervised branch and the unsupervised branch can work together to fully explore the potential value of the unannotated valid pixels.

Next, the implementation details of the clustering algorithm are further described. In the process of iterative solution using a random gradient descent algorithm, the execution of the clustering algorithm also uses a single iteration as the basic unit. In some embodiments, the step of performing unsupervised clustering on the semantic feature map comprises: performing repeated iterations by a class-centered clustering algorithm. Each single iteration process comprises three stages: initialization, sample division and parameter updating.

Specifically, in the initialization stage of a single iteration of the clustering algorithm, the algorithm first establishes an empty list of stored samples for the class j corresponding to each class-centered vector. In the next stage of sample division, the algorithm divides each sample vector into the sample list to which the class with the highest similarity belongs to according to the similarity between the class-centered vector and the sample vector. In the final stage of parameter updating, the algorithm updates the sample vector and the class-centered vector simultaneously by using a gradient back propagation method with reference to the fully supervised branch. By continuously executing the fully supervised cluster algorithm, the model completes the training of unsupervised cluster branches.

The loss function used in the semantic segmentation model is shown in FIG. 5. After the unsupervised branch is introduced, the loss function used to supervise model training actually consists of two parts. The first part is the fully supervised branch, containing the cross entropy loss value Lossₛᵤₚ (i.e. the first cross entropy loss value, Lᵢ in formula 1) generated by the likelihood map and the ground-truth map. The second part is the unsupervised branch, containing the cross entropy loss value Lossᵤₙₛᵤₚ (i.e. the second cross entropy loss value) generated by the clustering algorithm. Finally, the overall loss function is defined as Loss=Lossₛᵤₚ+λLossᵤₙₛᵤₚ, where λ is a proportional constant to balance the two branches, and the specific value can be determined according to the experiment. It is easy to understand that the calculation method of Lossᵤₙₛᵤₚ is the same as the method described in formula 1. The only difference is that Lossᵤₙₛᵤₚ is calculated by the result obtained after performing the clustering algorithm, which will not be described in detail here.

### 2. The Enhancement Module of a Class-Centered Clustering Algorithm

In this scheme, “the cosine distance of a unit vector of the class center” is introduced as the evaluation index of similarity between classes. As shown in formula 2, Ãₘ and Ãₙ are unit vectors corresponding to the class-centered vector Aₘ and the sample vector Aₙ, respectively, and the symbol ⊙ indicates the dot product operation between vectors. This section defines the similarity between Aₘ and Aₙ as s_{m,n}∈[−1,1]:

$${\tilde{A}}_{m} = \frac{{A}_{m}}{{‖ {A}_{m} ‖}_{2}} , {\tilde{A}}_{n} = \frac{{A}_{n}}{{‖ {A}_{n} ‖}_{2}} \qquad ( 2 )$$

$${s}_{m , n} = {\tilde{A}}_{m} □ {\tilde{A}}_{n}$$

In addition, in the initialization stage of each iteration of the clustering algorithm, the class-centered vector is normalized based on L2 norm.

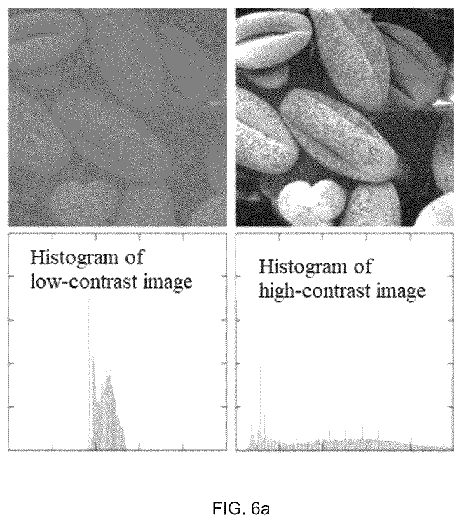

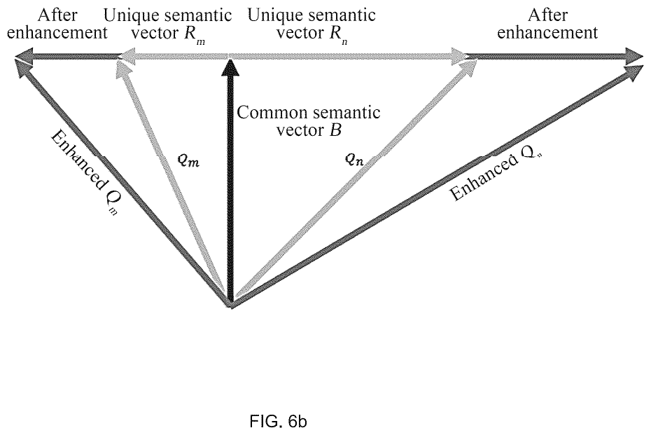

As shown in FIG. 6a, inspired by the contrast stretching operation in image processing, this scheme holds that for the overall distribution of sample vectors, if the unique vector R of all samples is stretched, the semantic feature map Q can have stronger semantic expressiveness. In order to enhance the expressiveness of sample semantic vectors, as shown in FIG. 6b, this scheme decomposes sample semantic vectors Qₘ and Qₙ into two orthogonal sub-vectors: “common semantic vector B” and “unique semantic vectors Rₘ and Rₙ”. The shared vector B represents the semantic representation shared among the sample vectors, while the unique vector R represents the unique semantic representation of the sample vector itself. On the other hand, from the perspective of sample pairs, after stretching the unique vector R, the included angle between Qₘ and Qₙ becomes much larger than that before stretching. Considering that the cosine similarity between unit vectors represents the similarity between samples, the larger included angle of vectors can also explain the phenomenon that: stretching the unique vector R can make the distance between samples longer and make the samples more dispersed in the feature space.

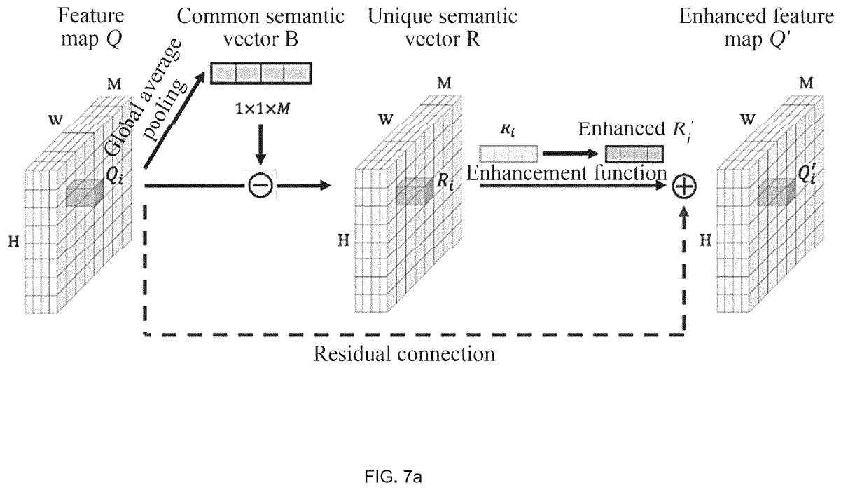

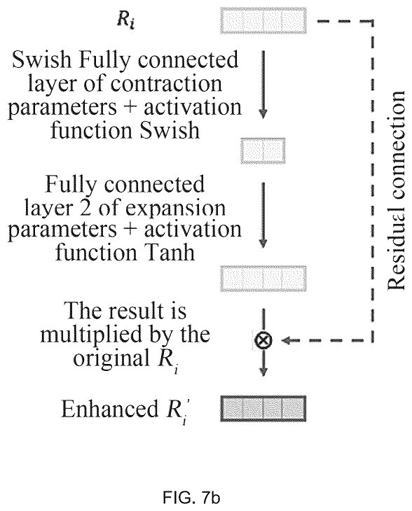

As shown in FIG. 7a, the contrast stretching module mainly comprises two stages: “common semantic vector extraction” and “unique semantic vector enhancement”. It should be noted that the operation of the contrast stretching module is performed before the semantic feature map Q is sent to the second training branch for training. In the stage of “common semantic vector extraction”, the global average pooling operation is performed on the whole semantic feature map Q to obtain the average vector of the whole semantic feature map Q, which is regarded as the common semantic vector B. Thereafter, the common semantic vector B is uniformly subtracted from each vector Qᵢ in the whole semantic feature map Q, so as to obtain the unique semantic vector map R. Thereafter, each vector Rᵢ in the unique semantic vector map R is enhanced by an enhancement function, so as to obtain the enhanced vector Rᵢ′. Finally, the enhanced vector Rᵢ′ is added to the original feature vector Qᵢ to obtain the enhanced feature map Q′. That is to say, the enhanced feature map Q′ is sent to the second training branch for training.

In the implementation of the enhancement function, this scheme refers to the design idea of a squeeze and excitation module. As shown in FIG. 7b, this section first condenses the semantics of the unique semantic vector Rᵢ through a fully connected layer of contraction parameters and a Swish activation function; and then further converts the condensed semantics into channel-by-channel enhancement coefficients through a fully connected layer of expansion parameters and a hyperbolic tangent Tan H activation function. Finally, by multiplying the obtained coefficients with the initial Rᵢ channel by channel, the enhancement of the unique semantic vector Rᵢ is completed.

### (2) Confidence Weighted Segmentation Method for the Problem of Incorrect Annotation

1. Brief introduction of KL Losses

The KL loss of the classifying tasks is defined as

$$KL ( {p}_{1 : C} , s , gt ) = \frac{1}{s} CE ( {p}_{1 : C} , gt ) + \frac{1}{2} log s \qquad ( 3 )$$

where CE(p_{1:C},gt) represents the cross entropy (CE) loss between the class probability p_{1:C} and the ground-truth annotation gt, and s represents the predicted uncertainty. (A smaller s means higher confidence).

By minimizing the KL loss related to s:

$$CE ( {p}_{1 : C} , gt ) = - log {p}_{gt} , \frac{\partial KL ( {p}_{1 : C} , s , gt )}{\partial s} = \frac{s - 2 CE ( {p}_{1 : C} , gt )}{2 {s}^{2}} , ⇒ \hat{s} = {argmin}_{s ∈ {□}^{+}} KL ( {p}_{1 : C} , s , gt ) = - 2 log {p}_{gt} \qquad ( 4 )$$

It can be found that the best s is related to the likelihood p_{gt} in the ground-truth channel. A well-trained model on a noiseless data set tends to be: p_{gt}→1⇒s→0 and p_{gt}→0⇒s→+∞. Therefore, high p_{gt} actually leads to 1/s of the large sample weight of CE loss in formula (4). In other words, KL loss will assign a larger weight to samples with high confidence. This weighting strategy may work well on the noiseless data set. However, it is often very fragile to apply the weighting strategy to noisy data sets, because those samples with high confidence have lower value and greater harm.

### 2. Use of Variance as Confidence

In this scheme, the variance p_{1:C} of the pixel-level possibility is taken as a confidence index. It is assumed that:

$${\sum }_{c} {p}_{c} = 1 , {p}_{c} ∈ [ 0 , 1 ] , \overline{p} = \frac{1}{C} \qquad ( 5 )$$

$$var = {\sum }_{c} {( {p}_{c} - \overline{p} )}^{2} ∈ [ 0 , \frac{C - 1}{{C}^{2}} ]$$

Therefore, two interesting inferences can be derived from the above formula. First, when the variance becomes the minimum value avarₘᵢₙ=0, the prediction probability values of all classes are actually equal. However, this probability distribution just shows that the model knows nothing about the class of samples. Conversely, when the variance becomes the maximum value varₘₐₓ, the probability value of only one class is 1, while those of other classes are all 0. This probability distribution shows that the model has absolute confidence in the prediction result of the samples. Therefore, this section thinks that the class probability variance var is positively correlated with the confidence of model prediction.

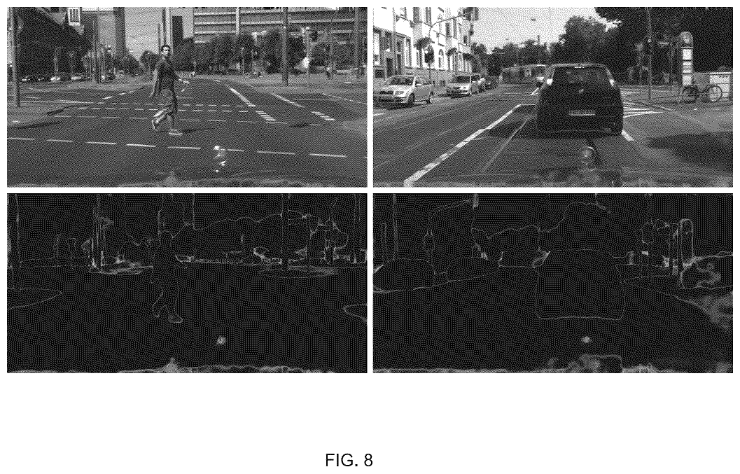

Besides the above theoretical analysis, this section also visualizes the low variance area. By training a segmentation model without any training skills on Cityscapes Coarse data set, the visualization results shown in FIG. 8 can be obtained. On the real image in the first row, the low variance area is marked as light. In the density map of the second row, the low variance area is given higher brightness. It can be seen that almost all the low variance pixels are distributed in the edge area of the adjacent semantic area. This is actually consistent with the consensus that segmentation models are not good at generating clear boundary lines of objects.

This scheme thinks that var can identify samples with different confidence values. Therefore, this scheme changes the strategy from “suppressing high confidence samples” to “suppressing high variation samples”.

It is worth noting that the definition of variance in this scheme is different from all the methods in the prior art. In the prior art, the variance of some schemes is obtained from the s term in KL loss, the variance of other schemes is calculated from two feature maps of different head outputs, and the variance of some schemes is calculated from their historical probability values in previous events. The structure of an object detection model based on deep learning is usually: input->backbone->neck->head->output. The backbone network extracts features, the neck extracts some more complex features, and then the head calculates the prediction output.

However, the variance of this scheme comes from a single feature map, which is calculated from the possibility of the pixel level. In addition, although the prediction confidence obtained from KL loss has a non-robust weighting strategy, the proposed variance is intuitive and lightweight and has fewer side effects.

### 3. Adversarial Reweighting Module

In order to explain the proposed reweighting strategy in detail, the training process is described as follows:

$${p}_{i , 1 : C} = S ( {x}_{i} ; {θ}_{S} ) \qquad ( 6 )$$

$${w}_{i} = W ( {v}_{i} ; {θ}_{W} )$$

$${l}_{i} = L ( {p}_{i , 1 : C} , {gt}_{i} )$$

$${\hat{θ}}_{S} = {arg min}_{{θ}_{s}} {\sum }_{i} {w}_{i} {l}_{i}$$

First, a segmentation model S(x) controlled by the parameter θ_{S} predicts the class probability p_{i,1:C} of each pixel xᵢ. Thereafter, the weight mapping function W(v) controlled by the parameter θ_{W} generates the weight wᵢ from the pixel-level variance vᵢ. Thereafter, the pixel-level loss lᵢ is calculated from p_{i,1:C} and gtᵢ. Finally, the optimal \hat{θ}_{S} is obtained by minimizing the weighted sum of lᵢ.

$$L ( v ) = {\sum }_{\{ i \vert {v}_{i} = v \}} {l}_{i} \qquad ( 7 )$$

Considering that all samples with vᵢ=v share the same weight W(v), after collecting all samples with vᵢ=v, this scheme defines the sum of its loss values as:

$${\sum }_{\{ i \vert {v}_{i} = v \}} {w}_{i} {l}_{i} = W ( v ) L ( v ) \qquad ( 8 )$$

$$Q = {\sum }_{i} {w}_{i} {l}_{i} = \int W ( v ; {θ}_{W} ) L ( v ; {θ}_{s} ) dv$$

For the sake of brevity, this scheme denotes the weight as Q. The foundation is laid in formulas (6), (7) and (8). Now, W(v;θ_{W}) and L(v;θ_{S}) are analyzed, respectively.

W(v;θ_{W}) is determined by the reweighting strategy in this scheme. The strategy of suppressing high variation samples requires W(v) to assign a smaller wᵢ to the samples with larger v, that is:

v₁>v₂⇒W(v₁)<W(v₂) (9)

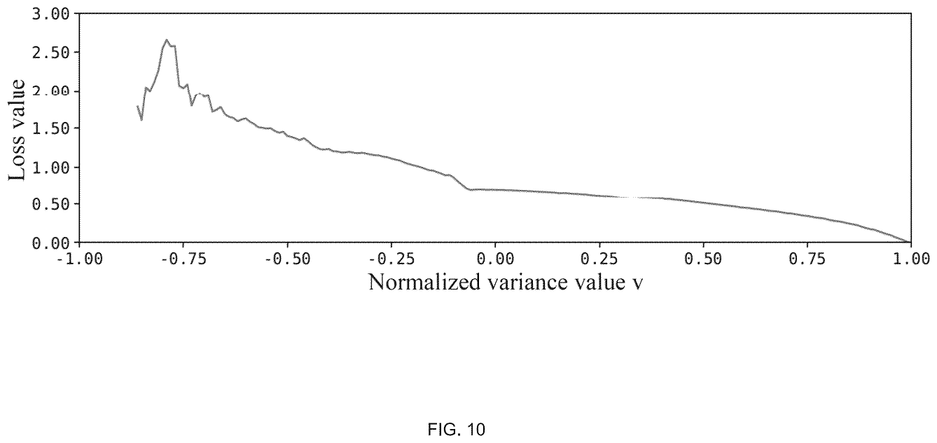

L(v;θ_{S}) is determined by the segmentation model of this scheme, and represents the sum of loss values in different variance intervals. To find out the curve shape of L(v;θ_{S}), this scheme counts Cityscapes data sets. Because this scheme usually performs iterative training in small batches, the expected value (average value) of the loss values is counted, rather than the sum thereof. As shown in FIG. 10, the average loss value in the low variance interval is smaller than that in the high variance interval. This section can use formula (10) to formally express this statistical result:

v₁>v₂⇒L(v₁)<L(v₂) (10)

This means that the average loss in the low confidence interval is greater than that in the high confidence interval.

According to formula (9) and formula (10), in this scheme, it can be said that W(v;θ_{W}) actually tends to focus on the high L(v) interval. More specifically, although the goal of S(x;θ_{S}) is to predict more accurate p_{i;1:C} and produce a lower weighted sum Q. W(v;θ_{W}) tends to assign a greater weight to samples with lower confidence, and produce higher Q. Therefore, the adversarial training strategy introduced in this scheme is:

$$\{ \begin{matrix}{θ}_{S} = {arg min}_{{θ}_{s}} Q , \\ {θ}_{w} = {arg min}_{{θ}_{w}} Q .\end{matrix} \qquad ( 11 )$$

Moreover, the weight mapping function W(v;θ_{W}) is named as the Adversarial Reweighting Module (ARM).

First, θₛ can only be adjusted by L(v), and θ_{W} can only be adjusted by Wᵥ. θ_{S} and θ_{W} are independent and parallel. Second, for continuous functions, the fastest increasing direction is opposite to the fastest decreasing direction. When θ_{S} is assigned a positive learning rate, it tends to minimize Q, and when θ_{W} is assigned a negative learning rate, it tends to maximize Q. Therefore, just changing the learning rate of θ_{W} to a negative value and minimizing Q as usual is enough to solve the formula (11) and optimize the ARM of this scheme.

ARM is designed to suppress high confidence samples. Its input is a pixel-level normalized variance vᵢ∈[−1,1]. Its output is a pixel-level sample weight wᵢ∈[0,1]. The curve shape is controlled by the parameter θ_{W}. The weight mapping function of ARM can be any representation, such as (av+b) or (a log v+b). However, the best hyper-parameters a and b should be found through many experiments, which wastes manpower and computing resources. Therefore, this scheme further designs a learnable mapping function W(v;θ_{W}), that is, Auto ARM, which can embed the mapping function into the multilayer perceptron. The optimal W(v;θ_{W}) can be obtained by only one experiment.

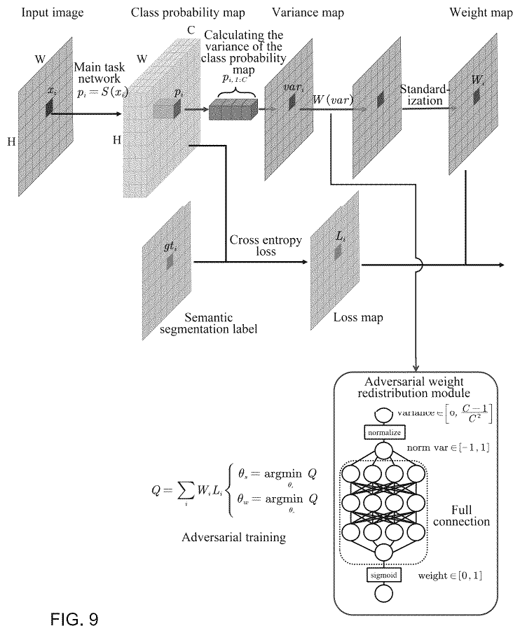

The ARM of this scheme can be easily connected to the existing segmentation model. For the automatic ARM, the training pipeline is illustrated in FIG. 9. In this scheme, first, the variance vᵢ within the pixel range is explicitly calculated by using the class-likelihood map, and then vᵢ is normalized from [0,(C−1)/C²] to [−1,1]. Next, this scheme uses the automatic ARM to map vᵢ to wᵢ, and constrains the weight map with ∥W∥ₚ=1,p>1, so as to obtain better convergence. Finally, the weighted sum of the weight map and the loss map is minimized as usual. However, by simply multiplying −1 by the learning rate of θ_{w}, this scheme realizes the adversarial training. It is worth mentioning that the automatic ARM of this scheme only contains 53 learnable parameters, which is quite light and only brings negligible computational overhead.

It can be understood that the same or similar parts in the above-mentioned embodiments can refer to each other, and the contents not explained in detail in some embodiments can refer to the same or similar contents in other embodiments.

It should be noted that in the description of the present disclosure, the terms “first” and “second” are only used for the purpose of description, and cannot be understood as indicating or implying relative importance. In addition, in the description of the present disclosure, unless otherwise stated, the meaning of “a plurality of” means at least two.

Any process or method description in the flow chart or otherwise described here can be understood as a module, segment or part of code that comprises one or more executable instructions for implementing steps of specific logical functions or processes. The scope of the preferred embodiments of the present disclosure comprises other implementations, in which functions can be performed out of the order shown or discussed, including in a substantially simultaneous manner or in a reverse order according to the functions involved, which should be understood by those skilled in the art to which the embodiments of the present disclosure belong.

It should be understood that various parts of the present disclosure can be implemented by hardware, software, firmware or the combination thereof. In the above embodiments, a plurality of steps or methods can be implemented by software or firmware stored in a memory and executed by a suitable instruction execution system. For example, if the steps or methods are implemented by hardware, as in another embodiment, the steps or methods can be implemented by any of the following technologies known in the art or the combination thereof: a discrete logic circuit with logic gates for realizing logic functions on data signals, an application specific integrated circuit with appropriate combinational logic gates, a programmable gate array (PGA), a field programmable gate array (FPGA), etc.

Those skilled in the art can understand that all or part of the steps involved in implementing the method of the above embodiment can be completed by instructing related hardware through a program. The program can be stored in a computer-readable storage medium. When being executed, the program comprises one of the steps of the method embodiment or the combination thereof.

In addition, each functional unit in each embodiment of the present disclosure may be integrated in a processing module, each unit may exist physically alone, or two or more units may be integrated in one module. The above integrated modules can be realized in the form of hardware or a software functional module. If the integrated module is implemented in the form of a software functional module and sold or used as an independent product, the integrated module can also be stored in a computer-readable storage medium.

The storage medium mentioned above can be a read-only memory, a magnetic disk or an optical disk, etc.

In the description of the specification, the description referring to the terms “one embodiment”, “some embodiments”, “examples”, “specific examples” or “some examples” means that the specific features, structures, materials or characteristics described in connection with the embodiment or example are included in at least one embodiment or example of the present disclosure. In the specification, the schematic expressions of the above terms do not necessarily refer to the same embodiment or example. Furthermore, the specific features, structures, materials or characteristics described may be combined in any one or more embodiments or examples in a suitable manner.

Although the embodiments of the present disclosure have been shown and described above, it can be understood that the above embodiments are exemplary and should not be construed as limitations of the present disclosure. Those skilled in the art can make changes, modifications, substitutions and variations to the above embodiments within the scope of the present disclosure.

1. A coarse annotation based semantic segmentation model training method, comprising the following steps:
sending an original image into a semantic segmentation model for processing;
acquiring a semantic feature map output by a specified convolution layer in the semantic segmentation model;
sending the semantic feature map to a first training branch for training to obtain a first cross entropy loss value, wherein the first training branch is a fully supervised branch depending on a ground-truth map;
sending the semantic feature map to a second training branch for training to obtain a second cross entropy loss value, wherein the second training branch is an unsupervised branch without a ground-truth map; and
determining an overall loss function according to the first cross entropy loss value and the second cross entropy loss value.

2. The method according to claim 1, wherein the specified convolution layer is the penultimate layer of the semantic segmentation model; and the first training branch is the last fully connected layer in the semantic segmentation model.

3. The method according to claim 1, wherein the first cross entropy loss value is:
Lᵢ=CE(Pᵢ,Yᵢ);
where Pᵢ=softmax(Tᵢ), Tᵢ=W_{FC}⊙Qᵢ, Qᵢ is the semantic feature map, W_{FC} is the model parameter of the last fully connected layer, the symbol ⊙ indicates matrix multiplication, Tᵢ is the output result of the last fully connected layer, and Yᵢ is the true class of valid pixels in the ground-truth map Y.

4. The method according to claim 1, wherein sending the semantic feature map to a second training branch for training comprises:
performing unsupervised clustering on the semantic feature map, and classifying unannotated sample vectors;
wherein the unannotated sample vectors are the feature vectors corresponding to the unannotated pixel in the semantic feature map.

5. The method according to claim 4, wherein the step of performing unsupervised clustering on the semantic feature map comprises:
performing repeated iterations by a class-centered clustering algorithm;
wherein each single iteration process comprises initialization, sample division and parameter updating.

6. The method according to claim 5, wherein:
in the initialization stage, an empty list of stored samples is established for the class corresponding to each class-centered vector;
in the sample division stage, according to the similarity between the class-centered vector and the sample vector, each sample vector is divided into the sample list to which the class with the highest similarity belongs to;
in the parameter updating stage, the sample vector and the class-centered vector are updated simultaneously by using a gradient back propagation method with reference to the fully supervised branch.

7. The method according to claim 6, further comprising:
in the initialization stage of each iteration, performing L2 norm-based normalization on the class-centered vector;
in the sample division stage, defining the similarity between the class-centered vector and the sample vector as:
s_{m,n}=Ãₘ∈Ãₙ;
where Ãₘ and Ãₙ are the unit vectors corresponding to the class-centered vector and the sample vector, respectively, and the symbol (indicates a dot product operation between the vectors.

8. The method according to claim 1, wherein prior to sending the semantic feature map to a second training branch for training, the method further comprises:
performing global average pooling operation on the whole semantic feature map to obtain the average vector of the whole semantic feature map Q, and taking the average vector as a common semantic vector B;
uniformly subtracting the common semantic vector B from each vector Qᵢ in the whole semantic feature map Q to obtain a unique semantic vector map R;
enhancing each vector Rᵢ in the unique semantic vector map R by using an enhancement function to obtain an enhanced vector Rᵢ′;
adding the enhanced vector Rᵢ′ to the initial feature vector Qᵢ to obtain an enhanced feature map Q′.

9. The method according to claim 8, wherein the step of enhancing by using an enhancement function comprises:
condensing the semantics of the unique semantic vector Rᵢ through a fully connected layer of contraction parameters and a Swish activation function;
converting the condensed semantic vectors into channel-by-channel enhancement coefficients by a fully connected layer of expansion parameters and a hyperbolic tangent Tan H activation function;
performing channel-by-channel multiplication of the obtained coefficients by the initial Rᵢ to complete the enhancement of the unique semantic vector Rᵢ.

10. A coarse annotation based semantic segmentation model training device, comprising:
an input module, which is configured to send an original image into a semantic segmentation model for processing;
an acquisition module, which is configured to acquire a semantic feature map output by a specified convolution layer in the semantic segmentation model;
a first training branch, which is configured to train the semantic feature map to obtain a first cross entropy loss value, wherein the first training branch is a fully supervised branch depending on a ground-truth map;
a second training branch, which is configured to train the semantic feature map to obtain a second cross entropy loss value, wherein the second training branch is an unsupervised branch without a ground-truth map; and
a determining module, which is configured to determine an overall loss function according to the first cross entropy loss value and the second cross entropy loss value.
